(19) United States
(12) Patent Application Publication
(10) Pub. No.: US 2020/0122377 A1
(43) Pub. Date: Apr. 23, 2020

(54) METHOD FOR DETERMINING A PHYSICAL RELATIONSHIP

(71) Applicant: ENGEL AUSTRIA GmbH, Schwertberg (AT)

(72) Inventor: Georg PILLWEIN, Linz (AT)

(21) Appl. No.: 16/589,635

(22) Filed: Oct. 1, 2019

(30) Foreign Application Priority Data
Oct. 3, 2018 (AT) A 50849/2018

(51) Int. Cl. B29C 45/76

(52) U.S. Cl. CPC B29C 45/766; B29C 2945/76936

(57) ABSTRACT

A method of determining a physical relationship between at least one setting parameter of a production cycle of a cyclically operating shaping machine and at least one selected process or quality parameter of the production cycle of the shaping machine, wherein a predetermined variation of a numerical value of the at least one setting parameter is effected in a sequence of production cycles, preferably from one production cycle to another, i and that for each production cycle of the sequence of production cycles the at least one selected process or quality parameter is determined, and that a check is made of the extent to which the at least one selected process or quality parameter has been influenced by the predetermined variation of the numerical value of the at least one setting parameter.

The invention concerns a method of determining a physical relationship between at least one setting parameter of a production cycle of a cyclically operating shaping machine and at least one selected process or quality parameter of the production cycle of the shaping machine and one cyclically operating shaping machine.

As regards generic shaping machines there is a plurality of process or quality parameters which are of interest to the operator. They can be directly or indirectly influenced by a plurality of setting parameters. An average operator will know only a few of the relationships which exist between the setting parameters on the one hand and the process or quality parameters on the other hand. Even in case the operator knows such relationships, he only knows them in qualitative form. The operator does, however, not know how changing a setting parameter will quantitatively affect the process or quality parameter/s which is/are dependent on that setting parameter, especially as that may be different from one shaping machine to another. It is a problem that, so far, the operator does not have any aids which in that respect would help him to at least qualitatively, and preferably also quantitatively estimate the consequences of a change in a setting parameter.

The object of the invention is to provide a generic method and a generic shaping machine in which the above-discussed problems are avoided.

This object is attained by a method having the features of claim 1 and a shaping machine having the features of claim 16.

Advantageous embodiments of the invention are defined in the dependent claims.

In a method according to the invention it is provided that, a predetermined variation of a numerical value of the at least one setting parameter is effected in a sequence of production cycles, preferably from one production cycle to another, and that after each production cycle of the sequence of production cycles the at least one selected process or quality parameter is determined and that a check is made of the extent to which the at least one selected process or quality parameter has been influenced by the predetermined variation of the numerical value of the at least one setting parameter.

In a shaping machine according to the invention it is provided that the control or regulation device is configured in an operating mode which can be triggered automatically or by an operator to effect a predetermined variation of a numerical value of at least one setting parameter in a sequence of production cycles of the shaping machine , and after each production cycle of the sequence of production cycles to determine at least one selected process or quality parameter, and to check the extent to which the at least one selected process or quality parameter has been influenced by the predetermined variation in the numerical value of the at least one setting parameter.

The invention is based on an ideally small and systematic variation in one or more setting parameter/s in the on-going production process of a cyclically operating shaping machine.

The variation is effected more preferably from shot to shot, therefore in successive production cycles.

The variation of the at least one setting parameter is effected by suitable actuators of the shaping machine. Any variable of a production process which can be influenced reproducibly by actuators can serve as a setting parameter.

The at least one selected process or quality parameter is determined by using suitable sensors of the shaping machine or external sensors. Any variable which is of interest to an operator and which can be determined using sensors (either indirectly or directly by using the signals of the sensors in an algorithm for determining the variable of interest) can serve as a process or quality parameter.

Depending on which regulation procedures are implemented in a shaping machine, one and the same parameter can function either as a setting parameter or as a process or quality parameter.

Of course, determining a possible relationship of the at least one setting parameter with a process and a quality parameter can be effected by a variation of the at least one setting parameter.

The invention is preferably used in relation to a shaping machine in the form of a plastic injection molding machine.

The shaping machine can have a control or regulation device which is configured according to the invention or for carrying out the method according to the invention can be brought into data-transmitting communication (for example a cloud service) with a control or regulation device which is implemented in a server arranged separately, for example far from the shaping machine, and which is configured in accordance with the invention. Of course, in the latter case the shaping machine itself can also be provided with a control or regulation device which then, however, does not have to be configured for carrying out the invention.

The variation is effected in a predetermined manner, that is to say in accordance with a pre-defined known pattern across the production cycles, for example in sine or cosine form, in the form of a rectangle function, in the form of a triangle function, with wavelet functions, pursuant to a statistical design of experiments (DoE experimental plan), or also random-based (but, of course, in such way that the random-based variation is known).

If several setting parameters are varied simultaneously, the pattern for each individual setting parameter will be selected is such way that the variations can be clearly distinguished from each other. That can be achieved, for example, with a sine, cosine, rectangle or triangle variation by means of different period durations. When producing an experimental plan this condition is in any case ensured.

The amplitude of the variation of the setting parameter or setting parameters should (in the ideal case) be selected is such way that the process and the quality features of the shaped parts are admittedly slightly influenced by both the individual parameters and also the relationship of the variations of several setting parameters, but remain within predetermined tolerances, that is to say the production process still continues to deliver good parts.

Of what kind the variation should be, in particular how great the amplitude and/or frequency of the variation should be, can be either estimated (if applicable by using simulations) or ascertained in test runs. It is also possible to automatically and systematically determine the kind of variation, in particular the amplitude and/or frequency of the variation.

The amplitude of the variation or variations can be automatically adapted on the basis of the reaction of process or quality parameters. For example, the amplitude can be automatically reduced to such an extent that the effect on other variables can still precisely be separated from the noise (=random fluctuations in the variables). As regards the frequency of the variation, it makes sense for same to be, for example, selected or established in accordance with the reaction time of the setting parameter to be varied. A change in the setting parameter cylinder temperature, for example, has a slower effect than a change in the dynamic pressure and should therefore be varied at a lower frequency.

The effect of the systematic variation can consequently be observed at both other process parameters and also quality parameters which are established. In particular regarding a sine or cosine variation this can be done, for example, by a Fourier analysis. By this it is possible to determine a local process or quality model describing the relationships between setting parameters and process or quality parameters at the operating point. If the operating point changes, it will generally be necessary to re-determine the relationships.

The models established can be used in many different ways, for example:
to communicate and represent to the operator information about relationships in the process and to assist with changing the settings or with a process optimization, for example in respect of the following:
   selection of a setting parameter
      representing/listing of process or quality parameters which are primarily influenced by that setting parameter,
      when entering a desired change in value, producing a prognosis of the resulting change in process or quality parameters
   selection of a process or quality parameter
      representing/listing of the setting parameters which (can) influence the selected process or quality parameter
      representing/listing of other process or quality parameters which are related to the selected process or quality parameter
      entering a desired change in the selected process or quality parameter leads to establishing a suggestion as to which setting parameters are to be changed to what extent in order to achieve the desired change
to automatically regulate process or quality parameters
   Examples of typical setting parameters:

metering volume

switching volume

switching pressure

injection profile

holding pressure profile

holding pressure time

cooling time

rotary speed profile

dynamic pressure profile

cylinder heating

tool heating

compression relief stroke

compression relief speed

closing force

temperature of a temperature control medium in a flow branch

temperature difference between return and flow of a temperature control branch

temperature media through-flow in a temperature control branch.

Examples of typical process parameters

injection volume

change in viscosity of a plastic melt

tool breathing

cushion of a plastic melt in a screw antechamber

switching pressure

injection pressure peak value

torque mean value metering drive

flow rate of the plastic melt

injection work

injection time

metering time

cycle time

cooling time

temperature difference between return and flow of a temperature control branch

temperature control media through-flow in a temperature control branch

tool wall temperature

internal mold pressure

results of a thermography of a component of the plastic injection molding machine, preferably of the tool

Examples of typical quality parameters

shaped part mass

shaped part dimensions (for example, determined tactilely or optically)

shrinkage

deformation

results of an optical test of the shaped part (with a camera or the like)

results of a thermography of the shaped part.

any form of inline quality control

possibly also from downstream quality control in case the exact allocation to the production data can be ensured.

Illustrative embodiments of the invention are discussed by means of the Figures for a sinusoidal variation of the following setting parameters in a plastic injection molding machine:

| | | | Mean | | Period |
|---|---|---|---|---|---|
| Setting parameter | Abbreviation | Unity | value | Amplitude | duration |
| Switching volume | C3u | cm³ | 6.5 | 0.1 | 3 |
| Injection speed | VS | cm³/s | 40 | 0.8 | 4 |
| Holding pressure | PN | bar | 400 | 8 | 5 |
| level | | | | | |
| Holding pressure | tN | sec | 10 | 0.2 | 7 |
| time | | | | | |
| Cooling time | tK | sec | 20 | 0.4 | 11 |
| Peripheral speed | DZ | m/s | 0.15 | 0.01 | 13 |
| Dynamic pressure | PS | bar | 80 | 1.6 | 17 |
| Nozzle | H2 | ° C. | 245 | 2.45 | 23 |
| temperature | | | | | |
| Temperature | H3 | ° C. | 235 | 2.35 | 31 |
| cylinder zone 1 | | | | | |
| Temperature | H4 | ° C. | 220 | 2.2 | 41 |
| Cylinder zone 2 | | | | | |
| Temperature | H5 | ° C. | 205 | 2.05 | 97 |
| cylinder zone 3 | | | | | |

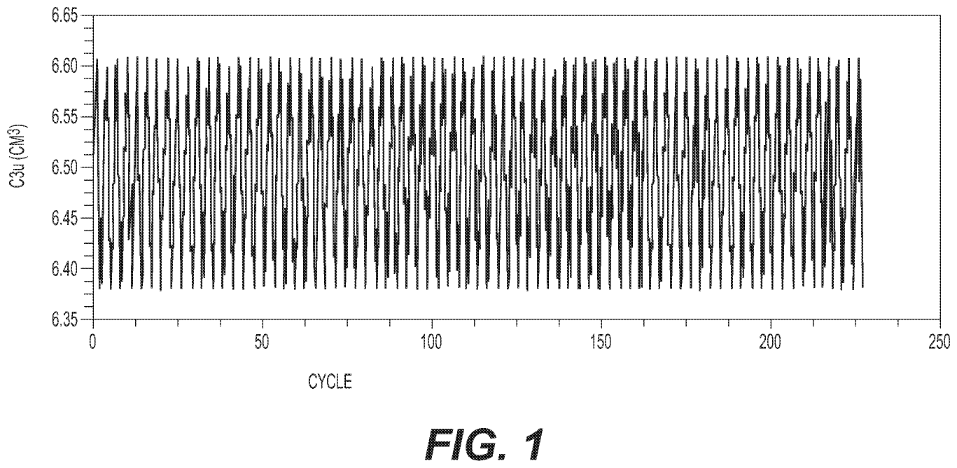

FIG. 1 shows a variation in the switching volume in relation to the cycle index:

mean value 6.50 cm3

amplitude 0.1 cm3

period duration 3 cycles

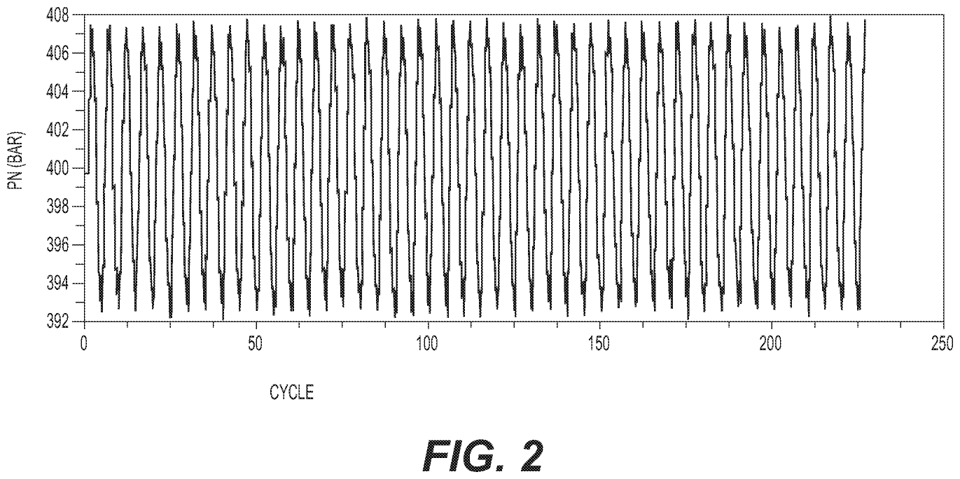

FIG. 2 shows a variation in the holding pressure level in relation to the cycle index:

mean value 400 bars

amplitude 8 bars

period duration 5 cycles

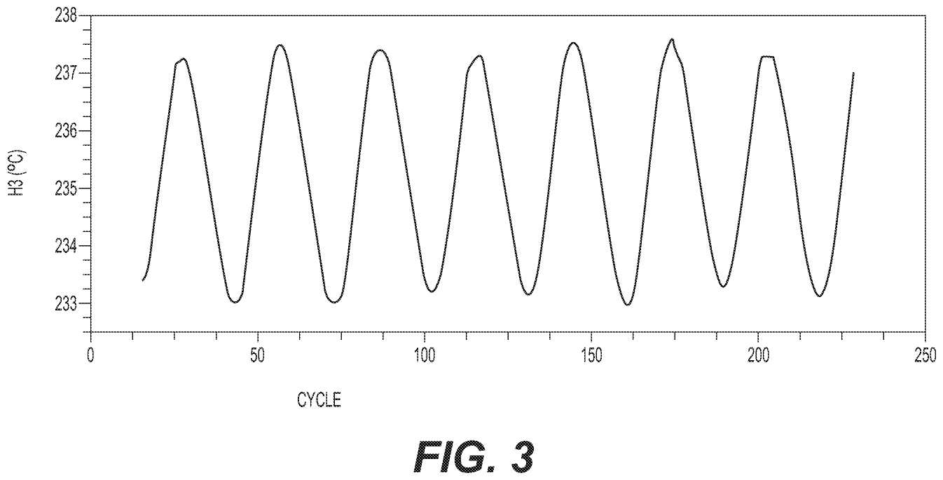

FIG. 3 shows a variation in the temperature of a cylinder zone “one” of a plasticizing cylinder in relation to the cycle index:

mean value 235° C.

amplitude 2.35° C.

period duration 31 cycles

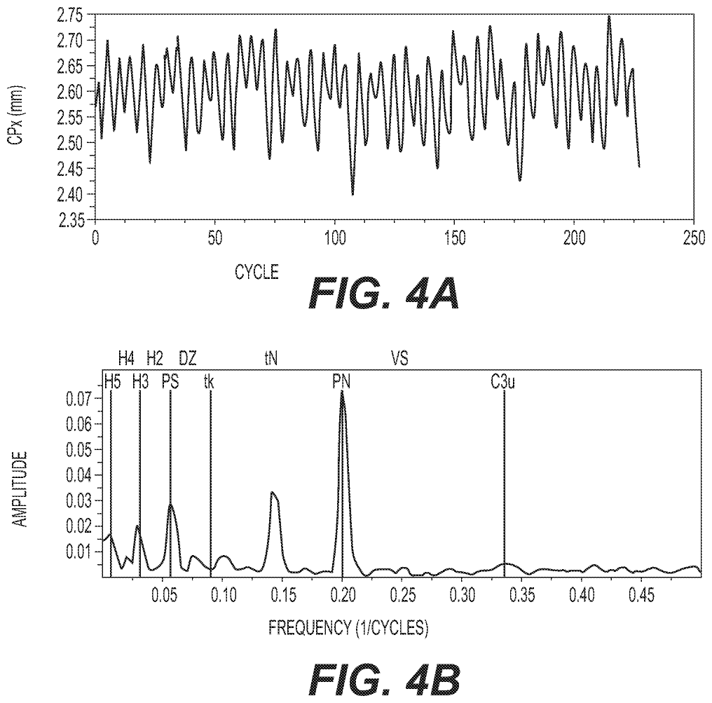

FIG. 4a shows the effect of the variation of several setting parameters on the process parameter CPx (mass cushion).

FIG. 4b shows the result of a Fourier analysis with Hanning window. The Fourier analysis shows peaks at the frequencies which correspond to the variations of H3 (cylinder heating zone “one”), PS (dynamic pressure), tN (holding pressure time), PN (holding pressure level). The process parameter mass cushion can therefore be influenced well by those setting parameters.

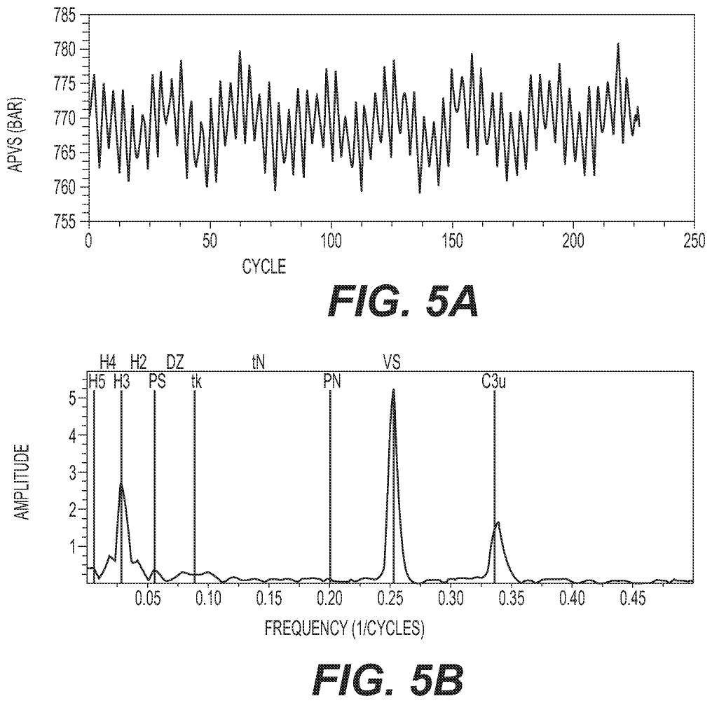

FIG. 5a shows the effect of the variation of several setting parameters on the process parameter APVs (injection pressure peak value).

FIG. 5b shows the result of a Fourier analysis with Hanning window. The Fourier analysis shows peaks at the frequencies which correspond to the variations of H3 (cylinder heating zone “one”), VS (injection speed), C3u (switching volume). The process parameter injection pressure peak value can therefore be influenced well by those setting parameters.

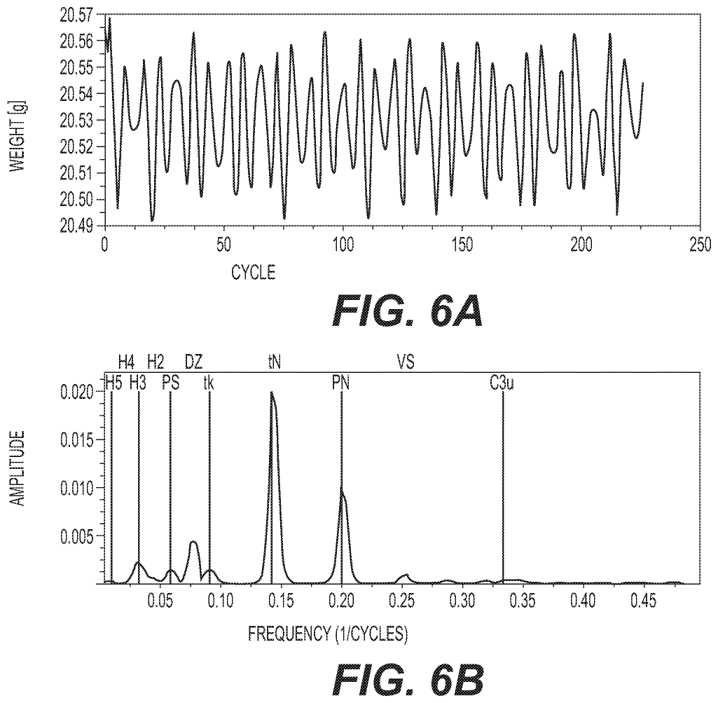

FIG. 6a shows the effect of the variation of several setting parameters on the quality parameter weight (actually shaped part mass).

FIG. 6b shows a Fourier analysis with Hanning window. The Fourier analysis shows peaks at the frequencies which correspond to the variations of H3 (cylinder heating zone “one”), PS (dynamic pressure), DZ (rotary speed), tN (holding pressure time) and PN (holding pressure level). The quality parameter weight can therefore be influenced well by those setting parameters.

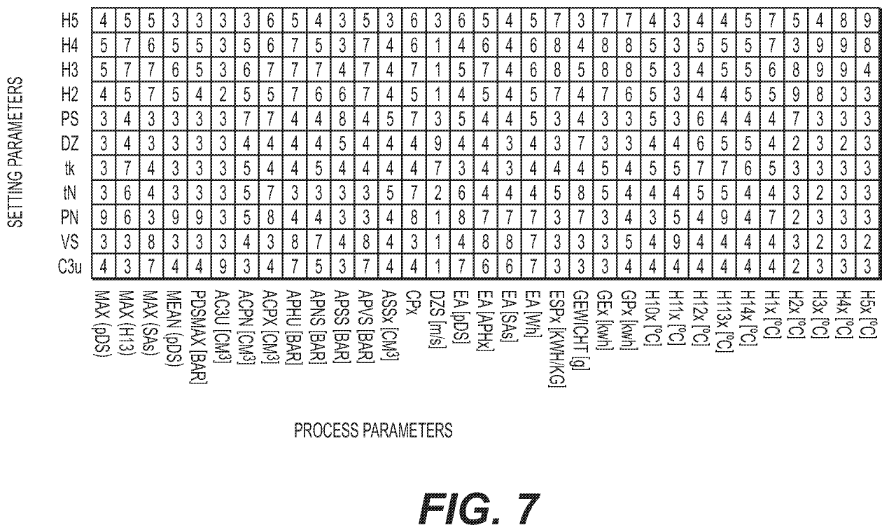

FIG. 7 shows an overview about the strength of the relationships between setting parameters (y-axis) and process parameters (x-axis) as a 2D plot by means of a scale from 1 to 9 (1—weak relationship, 9—strong relationship).

1. A method of determining a physical relationship between at least one setting parameter of a production cycle of a cyclically operating shaping machine and at least one selected process or quality parameter of the production cycle of the shaping machine, characterized in that a predetermined variation of a numerical value of the at least one setting parameter is effected in a sequence of production cycles, preferably from one production cycle to another, and that for each production cycle of the sequence of production cycles the at least one selected process or quality parameter is determined and that a check is made of the extent to which the at least one selected process or quality parameter has been influenced by the predetermined variation of the numerical value of the at least one setting parameter.

2. The method of claim 1, wherein the extent of the predetermined variation of the numerical value of the at least one setting parameter is effected in dependence on a predetermined tolerance for the shaped parts produced in a production cycle that consequently the production cycles of the sequence of production cycles deliver good parts.

3. The method of claim 1, wherein an adaptation of an amplitude and/or frequency of the predetermined variation of the numerical value of the at least one setting parameter is effected in dependence on the determined at least one process or quality parameter selected.

4. The method of claim 1, wherein the predetermined variation of the numerical value of the at least one setting parameter is effected in accordance with a sine or cosine function.

5. The method of claim 1, wherein the extent to which the at least one selected process or quality parameter has been influenced by the predetermined variation in the numerical value of the at least one setting parameter is checked by means of a Fourier analysis.

6. The method of claim 1, wherein the numerical values of at least two setting parameters are varied simultaneously, wherein the variations of the numerical values of the at least two setting parameters are selected in such way that the effects of the variations on the at least one selected process or quality parameter of the production cycle can be distinguished from each other.

7. The method of claim 1, wherein the numerical value of the at least one setting parameter is kept constant during a production cycle.

8. A method of operating a shaping machine using the results of the method of claim 1, wherein those process or quality parameters which are influenced by a variation of the numerical value of the at least one setting parameter are determined and/or represented or that the at least one setting parameter which influences a process or quality parameter by a variation of its numerical value is determined and/or represented.

9. The method of operating a shaping machine using the results of the method of claim 1, wherein upon entering a desired change of a numerical value of a setting parameter by an operator, a prognosis is made by way of a resulting change of influenced process or quality parameters.

10. The method of operating a shaping machine using the results of the method of claim 1, wherein upon entering a desired change in a process or quality parameter it is specified which setting parameter or setting parameters must be changed to what extent, so that the desired change in the process or quality parameter is set.

11. A method of regulating a shaping machine using the results of the method of claim 1, wherein at least one process or quality parameter selected is automatically regulated by changing at least one setting parameter.

12. A method of monitoring a production cycle of a shaping machine using the results of the method of claim 1, wherein a message for an operator and/or for a control or regulation device of the shaping machine is effected if the extent of the change in the process or quality parameter reaches or exceeds a predetermined threshold value.

13. The method of claim 1, wherein a plastic injection molding machine is used as the shaping machine.

14. The method of claim 13, wherein the at least one setting parameter is selected from the following list:
metering volume
switching volume
switching pressure
injection profile
holding pressure profile
holding pressure time
cooling time
rotary speed profile
dynamic pressure profile
cylinder heating
tool heating
compression relief stroke
compression relief speed
closing force
temperature of a temperature control medium in a flow branch
temperature difference between return and flow of a temperature control branch
temperature media through-flow in a temperature control branch.

15. A method of claim 1, wherein a process parameter is selected from the following list:
injection volume
change in viscosity of a plastic melt
tool breathing
cushion of a plastic melt in a screw antechamber
switching pressure
injection pressure peak value
torque mean value metering drive
flow rate of the plastic melt
injection work
injection time
metering time
cycle time
cooling time
temperature difference between return and flow of a temperature control branch
temperature control media through-flow in a temperature control branch
tool wall temperature
internal mold pressure
results of a thermography of a component of the plastic injection molding machine, preferably of the tool.

16. -The method of claim 12, wherein a quality parameter is selected from the following list:
shaped part mass
shaped part dimensions, preferably determined tactilely or optically
shrinkage
deformation
results of an optical testing of the shaped part
results of a thermography of the shaped part.

17. A cyclically operating shaping machine comprising: a plurality of actuators which serve to influence a production cycle of the shaping machine in dependence on setting parameters, wherein the shaping machine is provided with a control or regulation device or can be brought into data-transmitting connection with such, characterized in that the control or regulation device is configured in an operating mode which can be triggered automatically or by an operator in order to implement a predetermined variation of a numerical value of at least one setting parameter by means of at least one actuator of the plurality of actuators in a sequence of production cycles, preferably from one production cycle to another, of the shaping machine, and after each production cycle of the sequence of production cycles to determine at least one selected process or quality parameter and to check the extent to which the at least one process or quality parameter selected has been influenced by the predetermined variation of the numerical value of the at least one setting parameter.
